(19) United States
(12) Patent Application Publication
(10) Pub. No.: US 2018/0106938 A1
(43) Pub. Date: Apr. 19, 2018

(54) QUANTUM DOT BACKLIGHT MODULE

(71) Applicant: Wuhan China Star Optoelectronics Technology Co., Ltd., Wuhan City (CN)

(72) Inventors: Mei Han, Wuhan City (CN); Yan Cheng, Wuhan City (CN)

(21) Appl. No.: 15/112,430

(22) PCT Filed: May 23, 2016
(86) PCT No.: PCT/CN2016/083065

§ 371 Date: Jul. 19, 2016

(30) Foreign Application Priority Data
May 9, 2016 (CN) 201610302631.8

(51) Int. Cl. F21V 8/00

(52) U.S. Cl. CPC G02B 6/005; G02B 6/0055; G02F 1/133621; G02B 6/0031; G02B 6/0026; G02B 6/0073

(57) ABSTRACT

The present invention provides a quantum dot backlight module, which includes a quantum dot film arranged on a side of the light guide plate that is distant from the light reflector board and an optical coating layer arranged on a side of the quantum dot film that is distant from the light guide plate, or alternatively includes a quantum dot tube arranged between a light guide plate and a backlight source and an optical coating layer arranged on a side of the light guide plate that is adjacent to the quantum dot tube, so that for the purpose of emission of white backlighting, the optical coating layer is used to reflect a part of monochromatic light emitting from the backlight source toward the quantum dot film or the quantum dot tube for re-excitation for light emission so as to increase excitation performance of the quantum dot film or the quantum dot tube, improve brightness and gamut of the quantum dot backlight module, and enhance product quality.

### BACKGROUND OF THE INVENTION

### 1. Field of the Invention

The present invention relates to the field of liquid crystal display technology, and in particular to a quantum dot backlight module.

### 2. The Related Arts

Thin film transistor-liquid crystal displays (TFT-LCDs) have a variety of advantages, such as thin device body, low power consumption, and being free of radiation, and thus have wide applications, such as liquid crystal televisions, mobile phones, personal digital assistants (PDAs), digital cameras, computer monitors, and notebook computer screens, so as to take a leading position in the field of flat panel displays. Most of the liquid crystal displays that are currently available in the market are backlighting liquid crystal displays, which comprise a liquid crystal panel and a backlight module. The working principle of the liquid crystal panel is that a drive voltage is applied to a thin-film transistor (TFT) array substrate and a color filter (CF) substrate to control a rotation direction of the liquid crystal molecules located between the two substrates in order to refract out light emitting from the backlight module to generate an image.

Since the liquid crystal display panel itself does not emit light, light must be provided from the backlight module in order to normally display images. Thus, the backlight module is one of the key components of the liquid crystal displays. The backlight modules can be classified in two types, namely a side-edge backlight module and a direct backlight module, according to the site where light gets incident. The direct backlight module comprises a light source, such as a cold cathode fluorescent lamp (CCFL) or a light-emitting diode (LED), which is arranged at the backside of the liquid crystal panel to form a planar light source directly supplied to the liquid crystal panel. The side-edge backlight module comprises an LED light bar, which is arranged rearward of one side of the liquid crystal panel to serve as a backlighting source.

Heretofore, a thin film transistor liquid crystal display device has a gamut level that is generally around 72%. To increase the gamut level, quantum dot backlight module techniques have been proposed. A quantum dot light-emitting material follows a size effect of quantum dots and has a property that varies with the variation of quantum dot size. When optically or electrically excited, a quantum dot emits color light and the color of the light is related to the property thereof so that it is possible to gain control over the light emitting therefrom by varying the size thereof. A quantum dot light-emitting material exhibits advantages of having a concentrated light emission spectrum and high color purity. Application of the quantum dot light-emitting materials to the field of the display technology would help greatly improve the gamut of the conventional displays, allowing color restoration capability of the displays to be strengthened. A quantum dot backlight module takes advantage of such features of the quantum dots by using LED backlighting to irradiate a quantum dot layer so as to excite different colors of lights that may be mixed with a part of light transmitting through the quantum dot to form white light thereby improving light emission performance of the entire backlight module. However, the conventional quantum dot backlight modules all suffer a disadvantage of low brightness.

Referring to FIG. 1, a schematic view is provided for illustrating the structure of a conventional quantum dot backlight module, which comprises: in sequence from top to bottom, a color filter plate 1, a thin-film transistor (TFT) array layer 2, a quantum dot film 3, a light guide plate 4, and a light reflector board 5, and a blue-light light-emitting diode (LED) 6 is arranged at a side of the light guide plate 4. The blue-light LED 6 emits blue light that is reflected by the light reflector board 5 and guided by the light guide plate 4 to transmit into the quantum dot film 3, where a quantum dot material 7 contained in the quantum dot film 3 is excited to give off red light and green light that mix with blue light that transmits through the quantum dot film 3 to form white light that is incident onto the color filter plate 1 to generate light of three colors, red, green, and blue (RGB) having wide color gamut. Since quantum dot has an excitation efficiency lower than that of ordinary LED fluorescent powder, brightness provided by the quantum dot backlight module is relatively low.

Referring to FIG. 2, a schematic view is provided for illustrating the structure of another conventional quantum dot backlight module, which comprises: in sequence from top to bottom, a color filter plate 1′, a TFT array layer 2′, a diffuser film 3′, a light guide plate 4′, and a light reflector board 5′, and a blue-light LED 6′ is arranged at a side of the light guide plate 4′ and a quantum dot tube 7′ is arranged between the blue-light LED 6′ and the light guide plate 4′. The blue-light LED 6′ emits blue light that transmits into the quantum dot tube 7′ to excite a quantum dot material 8′ to generate red light and green light that mix with blue light that transmits through the quantum dot tube 7′ to form white light that is directed by the light reflector board 5′, the light guide plate 4′, and the diffuser film 3′ to get incident onto the color filter substrate 1′ to generate light of three colors, red, green, and blue (RGB) having wide color gamut. Due to the quantum dot backlight module comprising a quantum dot tube 7′, a distance between the blue-light LED 6′ and the light guide plate 4′ is increased so that the coupling efficiency of the light guide plate 4′ is reduced, making brightness thereof relatively low.

### SUMMARY OF THE INVENTION

An object of the present invention is to provide a quantum dot backlight module that provides high light emission brightness and wide gamut and improves product quality.

To achieve the above object, the present invention provides a quantum dot backlight module, which comprises: a light guide plate, a light reflector board arranged on a surface of the light guide plate, a backlight source arranged on a side of the light guide plate, and a quantum dot film arranged on an opposite surface of the light guide plate, wherein the quantum dot film has a surface that is distant from the light guide plate and is provided with an optical coating layer and the optical coating layer reflects light emitting from the backlight source to excite the quantum dot film.

The backlight source comprises a blue-light light-emitting diode (LED) and the backlight source emits blue light that excites the quantum dot film to give off white light.

The optical coating layer reflects the blue light to re-excite the quantum dot film.

The optical coating layer has a reflectivity of 40%-60% to light having a wavelength of 340 nm-480 nm.

The optical coating layer has a reflectivity of 50% to light having a wavelength of 340 nm-480 nm.

The present invention also provides a quantum dot backlight module, which comprises: a light guide plate, a light reflector board arranged on a surface of the light guide plate, a quantum dot tube arranged at a side of the light guide plate, and a backlight source arranged on one side of the quantum dot tube that is distant from the light guide plate;

wherein the light guide plate has a surface that is adjacent to the quantum dot tube and is provided with an optical coating layer and the optical coating layer reflects light emitting from the backlight source to excite the quantum dot tube.

The backlight source comprises a blue-light LED and the backlight source emits blue light that excites the quantum dot tube to give off white light.

The optical coating layer reflects the blue light to re-excite the quantum dot tube.

The optical coating layer has a reflectivity of 40%-60% to light having a wavelength of 340 nm-480 nm.

The optical coating layer has a reflectivity of 50% to light having a wavelength of 340 nm-480 nm.

The present invention further provides a quantum dot backlight module, which comprises: a light guide plate, a light reflector board arranged on a surface of the light guide plate, a backlight source arranged on a side of the light guide plate, and a quantum dot film arranged on an opposite surface of the light guide plate, wherein the quantum dot film has a surface that is distant from the light guide plate and is provided with an optical coating layer and the optical coating layer reflects light emitting from the backlight source to excite the quantum dot film;

wherein the backlight source comprises a blue-light LED and the backlight source emits blue light that excites the quantum dot film to give off white light; and

wherein the optical coating layer reflects the blue light to re-excite the quantum dot film.

The efficacy of the present invention is that the present invention provides a quantum dot backlight module, which comprises a quantum dot film arranged on a side of the light guide plate that is distant from the light reflector board and an optical coating layer arranged on a side of the quantum dot film that is distant from the light guide plate, or alternatively comprises a quantum dot tube arranged between a light guide plate and a backlight source and an optical coating layer arranged on a side of the light guide plate that is adjacent to the quantum dot tube, so that for the purpose of emission of white backlighting, the optical coating layer is used to reflect a part of monochromatic light emitting from the backlight source toward the quantum dot film or the quantum dot tube for re-excitation for light emission so as to increase excitation performance of the quantum dot film or the quantum dot tube, improve brightness and gamut of the quantum dot backlight module, and enhance product quality.

### BRIEF DESCRIPTION OF THE DRAWINGS

The features and technical contents of the present invention will be better understood by referring to the following detailed description and drawings the present invention. However, the drawings are provided for the purpose of reference and illustration and are not intended to limit the scope of the present invention.

In the drawing:

FIG. 1 is a schematic view illustrating the structure of a conventional quantum dot backlight module;

FIG. 2 is a schematic view illustrating the structure of another conventional quantum dot backlight module;

FIG. 3 is a schematic view illustrating the structure of a quantum dot backlight module according to a first embodiment of the present invention; and

FIG. 4 is a schematic view illustrating the structure of a I quantum dot backlight module according to a second embodiment of the present invention.

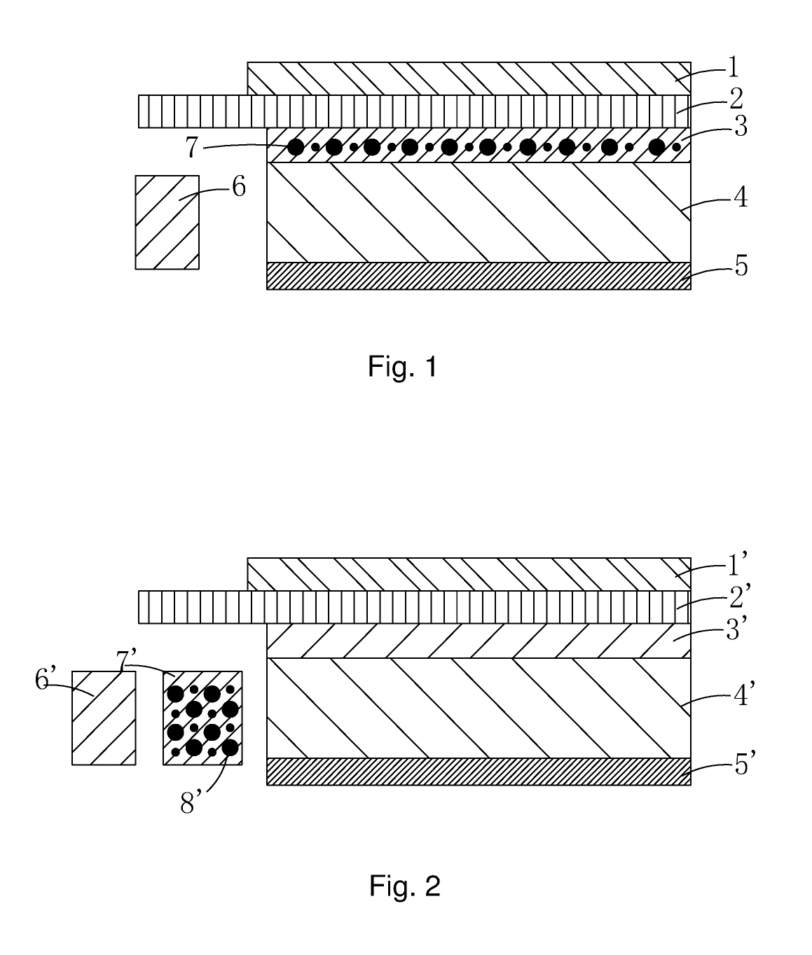

### DETAILED DESCRIPTION OF THE PREFERRED EMBODIMENTS

To further expound the technical solution adopted in the present invention and the advantages thereof, a detailed description is given to a preferred embodiment of the present invention with reference to the attached drawings.

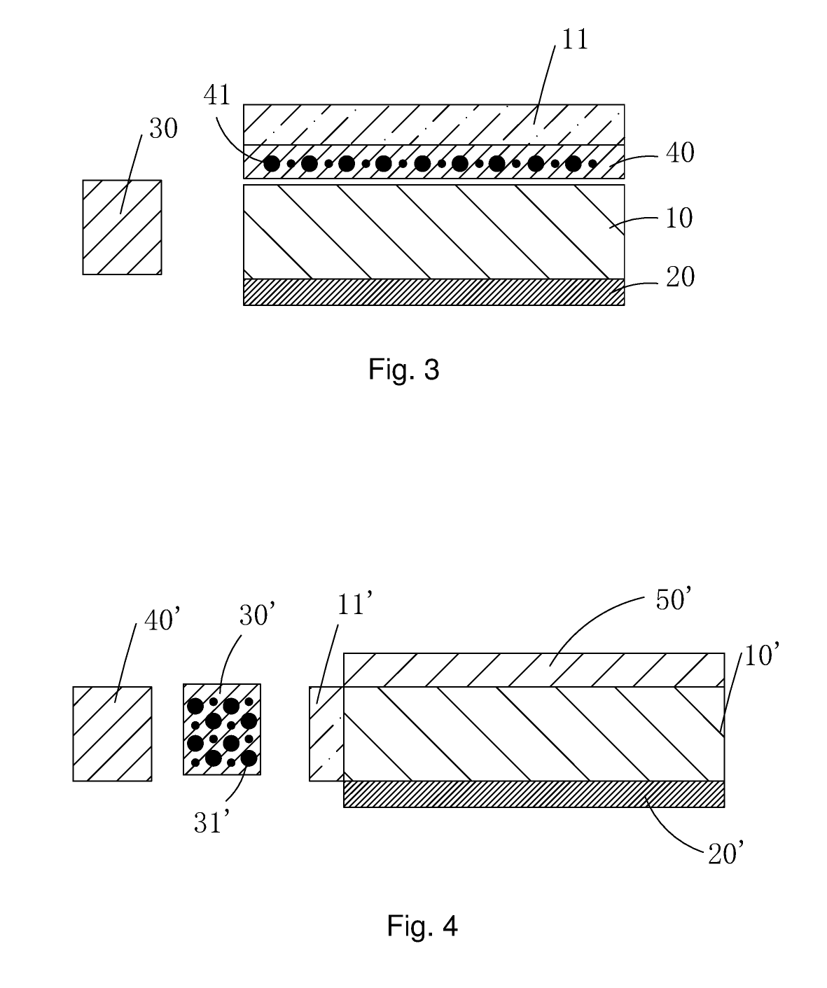

Referring to FIG. 3, a schematic view is provided for illustrating the structure of a quantum dot backlight module according to a first embodiment of the present invention, which comprises: a light guide plate 10, a light reflector board 20 arranged on a surface of the light guide plate 10, a backlight source 30 arranged on a side of the light guide plate 10, and a quantum dot film 40 arranged on an opposite surface of the light guide plate 10.

The quantum dot film 40 has a surface that is distant from the light guide plate 10 and is provided with an optical coating layer 11. The optical coating layer 11 reflects light emitting from the backlight source 30 to excite the quantum dot film 40.

Specifically, the quantum dot film 40 comprises a quantum dot material 41 that can be excited to emit a color light having a color different from monochromatic light emitting from and the backlight source 30.

Specifically, in the instant embodiment, the backlight source 30 comprises a blue-light LED (Light-Emitting Diode), which emits blue light.

Specifically, the quantum dot material 41 comprises a red quantum dot material and a green quantum dot material.

Preferably, the quantum dot material 41 comprises one or multiple ones of CdSe, CdS, CdTe, ZnS, ZnSe, CuInS, and ZnCuInS.

Specifically, the optical coating layer 11 has a high reflectivity to blue light and may reflect blue light to re-excite the quantum dot film 40.

Preferably, the optical coating layer 11 has a reflectivity of 40%-60% to light having a wavelength of 340 nm-480 nm.

More preferably, the optical coating layer 11 has a reflectivity of 50% to light having a wavelength of 340 nm-480 nm.

Specifically, the backlight source 30 emits blue light to excite the quantum dot film 40 to emit white light.

Specifically, the operation of the quantum dot backlight module according to the first embodiment of the present invention is as follows: The backlight source 30 emits blue light that transmits into the light guide plate 10 and is reflected by the light reflector board 20 to be further guided by the light guide plate 10 so that the blue light emitting from the backlight source 30 gets incident into the quantum dot film 40 to excite the quantum dot material 41 contained in the quantum dot film 40 to give off red light and green light, while a part of the blue light transmits through the quantum dot film 40 and gets incident onto the optical coating layer 11, and a part of the incident blue light is reflected by the optical coating layer 11 back into the quantum dot film 40, due to the high reflectivity thereof for blue light, to re-excite the quantum dot material 41 contained in the quantum dot film 40 to emit red light and green light. The red light and green light resulting from excitation of the quantum dot material 41 pass through the optical coating layer 11 and mix with a part of the blue light transmitting through the optical coating layer 11 to form white light so as to complete supplying of backlighting. Since the optical coating layer 11 shows a high reflectivity to blue light, namely having a reflectivity of 40%-60% for light having a wavelength of 340 nm-480 nm, the blue light emitting from the backlight source 30 can be reflected to excite, in multiple times, the quantum dot material 41 contained in the quantum dot film 40 to emit red light and green light so as to, when compared with the prior art, greatly increase excitation performance of the quantum dot film, improve brightness or gamut of the quantum dot backlight module, and enhance product quality.

Referring to FIG. 4, a schematic view is provided for illustrating the structure of a quantum dot backlight module according to a second embodiment of the present invention, which comprises: a light guide plate 10′, a light reflector board 20′ arranged on a surface of the light guide plate 10′, a quantum dot tube 30′ arranged at a side of the light guide plate 10′, and a backlight source 40′ arranged on one side of the quantum dot tube 30′ that is distant from the light guide plate 10′.

The light guide plate 10′ has a surface that is adjacent to the quantum dot tube 30′ and is provided with an optical coating layer 11′. The optical coating layer 11′ reflects light emitting from the backlight source 40′ to excite the quantum dot tube 30′.

Specifically, the quantum dot backlight module further comprises a diffuser film 50′ arranged on a side of the light guide plate 10′ that is distant from the light reflector board 20′.

Specifically, the quantum dot tube 30′ comprises a quantum dot material 31′ that can be excited to emit a color light having a color different from monochromatic light emitting from and the backlight source 40′.

Specifically, in the instant embodiment, the backlight source 40′ comprises a blue-light LED, which emits blue light.

Specifically, the quantum dot material 31′ comprises a red quantum dot material and a green quantum dot material.

Preferably, the quantum dot material 31′ comprises one or multiple ones of CdSe, CdS, CdTe, ZnS, ZnSe, CuInS, and ZnCuInS.

Specifically, the optical coating layer 11′ has a high reflectivity to blue light and may reflect blue light to re-excite the quantum dot tube 30′.

Preferably, the optical coating layer 11′ has a reflectivity of 40%-60% to light having a wavelength of 340 nm-480 nm.

More preferably, the optical coating layer 11′ has a reflectivity of 50% to light having a wavelength of 340 nm-480 nm.

Specifically, the backlight source 40′ emits blue light to excite the quantum dot film 30′ to emit white light.

Specifically, the operation of the quantum dot backlight module according to the second embodiment of the present invention is as follows: The backlight source 40′ emits blue light that transmits into the quantum dot tube 30′ to excite the quantum dot material 31′ contained in the quantum dot tube 30′ to give off red light and green light and a part of the blue light transmits through the quantum dot tube 30′ and gets incident onto the optical coating layer 11′, so that a part of the incident blue light is reflected by the optical coating layer 11′ back to the quantum dot tube 30′, due to the high reflectivity thereof for blue light, to re-excite the quantum dot material 31′ contained in the quantum dot tube 30′ to emit red light and green light. The red light and green light emitting from the quantum dot material 31′ of the quantum dot tube 30′ pass through the optical coating layer 11 and mix with a part of the blue light transmitting through the optical coating layer 11′ to form white light, which is reflected by the light reflector board 20 and subsequently guided by the light guide plate 10 to complete supplying of backlighting. Since the optical coating layer 11 shows a high reflectivity to blue light, namely having a reflectivity of 40%-60% for light having a wavelength of 340 nm-480 nm, the blue light emitting from the backlight source 40′ can be reflected to excite, in multiple times, the quantum dot material 31′ contained in the quantum dot tube 30′ to emit red light and green light so as to, when compared with the prior art, greatly increase excitation performance of the quantum dot tube, improve brightness or gamut of the quantum dot backlight module, and enhance product quality.

In summary, the present invention provides a quantum dot backlight module, which comprises a quantum dot film arranged on a side of the light guide plate that is distant from the light reflector board and an optical coating layer arranged on a side of the quantum dot film that is distant from the light guide plate, or alternatively comprises a quantum dot tube arranged between a light guide plate and a backlight source and an optical coating layer arranged on a side of the light guide plate that is adjacent to the quantum dot tube, so that for the purpose of emission of white backlighting, the optical coating layer is used to reflect a part of monochromatic light emitting from the backlight source toward the quantum dot film or the quantum dot tube for re-excitation for light emission so as to increase excitation performance of the quantum dot film or the quantum dot tube, improve brightness and gamut of the quantum dot backlight module, and enhance product quality.

Based on the description given above, those having ordinary skills of the art may easily contemplate various changes and modifications of the technical solution and technical ideas of the present invention and all these changes and modifications are considered within the protection scope of the present invention defined in the appended claims.

What is claimed is:

1. A quantum dot backlight module, comprising: a light guide plate, a light reflector board arranged on a surface of the light guide plate, a backlight source arranged on a side of the light guide plate, and a quantum dot film arranged on an opposite surface of the light guide plate, wherein the quantum dot film has a surface that is distant from the light guide plate and is provided with an optical coating layer and the optical coating layer reflects light emitting from the backlight source to excite the quantum dot film.

2. The quantum dot backlight module as claimed in claim 1, wherein the backlight source comprises a blue-light light-emitting diode (LED) and the backlight source emits blue light that excites the quantum dot film to give off white light.

3. The quantum dot backlight module as claimed in claim 2, wherein the optical coating layer reflects the blue light to re-excite the quantum dot film.

4. The quantum dot backlight module as claimed in claim 3, wherein the optical coating layer has a reflectivity of 40%-60% to light having a wavelength of 340 nm-480 nm.

5. The quantum dot backlight module as claimed in claim 3, wherein the optical coating layer has a reflectivity of 50% to light having a wavelength of 340 nm-480 nm.

6. A quantum dot backlight module, comprising: a light guide plate, a light reflector board arranged on a surface of the light guide plate, a quantum dot tube arranged at a side of the light guide plate, and a backlight source arranged on one side of the quantum dot tube that is distant from the light guide plate;
wherein the light guide plate has a surface that is adjacent to the quantum dot tube and is provided with an optical coating layer and the optical coating layer reflects light emitting from the backlight source to excite the quantum dot tube.

7. The quantum dot backlight module as claimed in claim 6, wherein the backlight source comprises a blue-light light-emitting diode (LED) and the backlight source emits blue light that excites the quantum dot tube to give off white light.

8. The quantum dot backlight module as claimed in claim 7, wherein the optical coating layer reflects the blue light to re-excite the quantum dot tube.

9. The quantum dot backlight module as claimed in claim 7, wherein the optical coating layer has a reflectivity of 40%-60% to light having a wavelength of 340 nm-480 nm.

10. The quantum dot backlight module as claimed in claim 7, wherein the optical coating layer has a reflectivity of 50% to light having a wavelength of 340 nm-480 nm.

11. A quantum dot backlight module, comprising: a light guide plate, a light reflector board arranged on a surface of the light guide plate, a backlight source arranged on a side of the light guide plate, and a quantum dot film arranged on an opposite surface of the light guide plate, wherein the quantum dot film has a surface that is distant from the light guide plate and is provided with an optical coating layer and the optical coating layer reflects light emitting from the backlight source to excite the quantum dot film;
wherein the backlight source comprises a blue-light light-emitting diode (LED) and the backlight source emits blue light that excites the quantum dot film to give off white light; and
wherein the optical coating layer reflects the blue light to re-excite the quantum dot film.

12. The quantum dot backlight module as claimed in claim 11, wherein the optical coating layer has a reflectivity of 40%-60% to light having a wavelength of 340 nm-480 nm.

13. The quantum dot backlight module as claimed in claim 11, wherein the optical coating layer has a reflectivity of 50% to light having a wavelength of 340 nm-480 nm.
